(19) United States
(12) Patent Application Publication
(10) Pub. No.: US 2008/0107321 A1
(43) Pub. Date: May 8, 2008

(54) Spiculation detection method and apparatus for CAD

(75) Inventor: Seungseok Oh, Sunnyvale, CA (US)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/591,472

(22) Filed: Nov. 2, 2006

(51) Int. Cl. G06K 9/00

(52) U.S. Cl. 382/132

(57) ABSTRACT

A method and an apparatus identify a spicule candidate in a medical image. The method according to one embodiment accesses digital image data representing an image including a tissue region; processes the digital image data by generating at least one line orientation map and at least one line strength map for the tissue region for at least one scale, using separable filters; calculates spicule feature values based on the at least one line orientation map and the at least one line strength map; and identifies a spicule candidate based on the calculated features values.

### BACKGROUND OF THE INVENTION

1. Field of the Invention

The present invention relates to a digital image processing technique, and more particularly to a method and apparatus for processing medical images and detecting malignant areas in a medical image.

2. Description of the Related Art

Mammography images and identification of abnormal structures in mammography images are important tools for diagnosis of medical problems of breasts. For example, identification of cancer structures in mammography images is important and useful for prompt treatment and prognosis.

Reliable cancer detection, however, is difficult to achieve because of variations in anatomical shapes of breasts and medical imaging conditions. Such variations include: 1) anatomical shape variations between breasts of various people or breasts of the same person; 2) lighting variations for medical images of breasts, taken at different times; 3) pose and view changes in mammograms; 4) change in anatomical structure of breasts due to aging of people; etc. Moreover, malignant lesions are often difficult to distinguish from benign lesions. Such imaging situations pose challenges for both manual identification and computer-aided detection of cancer in breasts.

One way to detect cancer in breasts is to look for signs of malignant masses. Signs of malignant masses may often be very subtle, especially in the early stages of cancer. However, such early cancer stages are also the most treatable, hence detecting subtle signs of malignant masses offers great benefits to patients. Malignant areas in breasts (and in other organs) often appear as irregular regions surrounded by patterns of star-like, radiating linear structures, also called spicules, or spiculated structures. Since malignant masses are often accompanied by spiculated structures, spiculated margin is a strong indicator of malignant masses. Moreover, spiculated structures indicate a much higher risk of malignancy, than calcifications and other types of structural mass changes.

Typical/conventional spiculation detection methods employ two-step approaches, which first extract line structures, and then compute features based on the detected lines. Thus, the performance of spicular detection for typical/conventional spiculation detection methods depends heavily on the performance of line structure extraction. Hence, spiculation detection is often difficult or ineffective if the extracted line structures are not good enough for spiculation detection. One spiculation detection technique is described in “Detection of Stellate Distortions in Mammograms”, by N. Karssemeijer and G. M. te Brake, IEEE Transactions on Medical Imaging, Vol. 15, No. 5, October 1996, p. 611-619. In the technique described in this work, a line structure map is constructed using a steerable filter approach, which is a method to efficiently compute maximum filtering response of breast images with a line-like kernel. A statistical analysis is then applied to detect spiculated structures based on the line structure map. This technique, however, still poses computational problems for automated detection of spiculated structures, because of the large computational load required by the technique. Moreover, the statistical analysis used to detect spiculated structures in this technique does not characterize well aspects of spiculated structures, such as the directional diversity of spiculated line structures. Hence, this technique encounters challenges when used for automated detection of spiculated structures in breasts.

Disclosed embodiments of this application address these and other issues by implementing methods and apparatuses for spiculation detection using separable steerable filters, to extract line structure maps for mammography images. The computational load is significantly reduced by using separable steerable filters. Line structure maps for mammography images are then characterized using multiple features related to spiculation of line structures, and overall spiculation scores are extracted for pixels inside mammography images. Spiculated structures are then identified using extracted spiculation scores. Methods and apparatuses described in this application can implement spicule detection algorithms that enhance mass detection capability of Computer Aided Design (CAD) systems. The methods and apparatuses described in this application can also be used for detection of spiculated structures in other anatomical parts besides breasts.

### SUMMARY OF THE INVENTION

The present invention is directed to a method and an apparatus for identifying a spicule candidate in a medical image. According to a first aspect of the present invention, an image processing method for identifying a spicule candidate in a medical image comprises: accessing digital image data representing an image including a tissue region; processing the digital image data by generating at least one line orientation map and at least one line strength map for the tissue region for at least one scale, using separable filters; calculating spicule feature values based on the at least one line orientation map and the at least one line strength map; and identifying a spicule candidate based on the calculated features values.

According to a second aspect of the present invention, an image processing apparatus for identifying a spicule candidate in a medical image comprises: an image data input unit for accessing digital image data representing an image including a tissue region; a line structure extraction unit for processing the digital image data, the line structure extraction unit generating at least one line orientation map and at least one line strength map for the tissue region for at least one scale, using separable filters; a feature map generator unit for calculating spicule feature values based on the at least one line orientation map and the at least one line strength map; and a spicule candidate determining unit for identifying a spicule candidate based on the calculated features values.

### BRIEF DESCRIPTION OF THE DRAWINGS

Further aspects and advantages of the present invention will become apparent upon reading the following detailed description in conjunction with the accompanying drawings, in which:

FIG. 1 is a general block diagram of a system including an image processing unit for spiculation detection according to an embodiment of the present invention;

FIG. 2 is a block diagram illustrating in more detail aspects of the image processing unit for spiculation detection according to an embodiment of the present invention;

FIG. 3 is a flow diagram illustrating operations performed by an image processing unit for spiculation detection according to an embodiment of the present invention illustrated in FIG. 2;

FIG. 4 is a block diagram illustrating an exemplary line structure extraction unit included in an image processing unit for spiculation detection according to an embodiment of the present invention illustrated in FIG. 2;

FIG. 5A is a flow diagram illustrating operations performed by an exemplary line structure extraction unit included in an image processing unit for spiculation detection according to an embodiment of the present invention illustrated in FIG. 4;

FIG. 5B is a flow diagram illustrating details of operations performed by an exemplary line structure extraction unit included in an image processing unit for spiculation detection according to an embodiment of the present invention illustrated in FIG. 5A;

FIG. 6 is a flow diagram illustrating operations performed by a line strength map generation unit included in a line structure extraction unit, for multiscale line structure extraction using steerable filters according to an embodiment of the present invention illustrated in FIGS. 5A and 5B;

FIG. 7 is a flow diagram illustrating operations performed by a line strength map generation unit included in a line structure extraction unit, for performing convolution operations using separable basic kernels to obtain line strength and orientation according to an embodiment of the present invention illustrated in FIG. 6;

FIG. 8A illustrates an exemplary breast image including a spiculation structure;

FIG. 8B illustrates an exemplary fine scale line strength map for the breast image in FIG. 8A, obtained by a line strength map generation unit according to an embodiment of the present invention illustrated in FIG. 5B;

FIG. 8C illustrates an exemplary middle scale line strength map for the breast image in FIG. 8A, obtained by a line strength map generation unit according to an embodiment of the present invention illustrated in FIG. 5B;

FIG. 8D illustrates an exemplary coarse scale line strength map for the breast image in FIG. 8A, obtained by a line strength map generation unit according to an embodiment of the present invention illustrated in FIG. 5B;

FIG. 8E illustrates an exemplary fine scale thinned line strength binary map for the breast image in FIG. 8A, obtained by a line strength map generation unit according to an embodiment of the present invention illustrated in FIG. 5B;

FIG. 8F illustrates an exemplary middle scale thinned line strength binary map for the breast image in FIG. 8A, obtained by a line strength map generation unit according to an embodiment of the present invention illustrated in FIG. 5B;

FIG. 8G illustrates an exemplary coarse scale thinned line strength binary map for the breast image in FIG. 8A, obtained by a line strength map generation unit according to an embodiment of the present invention illustrated in FIG. 5B;

FIG. 8H illustrates an exemplary line structure image for the breast image in FIG. 8A, obtained by a line and direction merging unit according to an embodiment of the present invention illustrated in FIG. 5B;

FIG. 8I illustrates another exemplary breast image;

FIG. 8J illustrates an exemplary line structure image for the breast image in FIG. 8I, obtained by a line and direction merging unit, before pectoral edge removal, according to an embodiment of the present invention illustrated in FIG. 5B;

FIG. 8K illustrates an exemplary line structure image for the breast image in FIG. 8I, obtained by a selective line removal unit after pectoral edge removal, according to an embodiment of the present invention illustrated in FIG. 5B;

FIG. 9 is a flow diagram illustrating operations performed by a feature map generator unit included in an image processing unit for spiculation detection according to an embodiment of the present invention illustrated in FIG. 2;

FIG. 10A illustrates aspects of the operation of calculating spiculation features by a feature map generator unit included in an image processing unit for spiculation detection according to an embodiment of the present invention illustrated in FIG. 9;

FIG. 10B illustrates an exemplary mammogram ROI image including spiculation structures;

FIG. 10C illustrates a line structure map extracted for the exemplary mammogram ROI image illustrated in FIG. 10B, according to an embodiment of the present invention illustrated in FIG. 5B;

FIG. 10D illustrates a map of radiating lines obtained from the line structure map illustrated in FIG. 10C, according to an embodiment of the present invention illustrated in FIG. 10A; and

FIG. 11 is a flow diagram illustrating operations performed by a spicule candidate determining unit included in an image processing unit for spiculation detection according to an embodiment of the present invention illustrated in FIG. 2.

### DETAILED DESCRIPTION

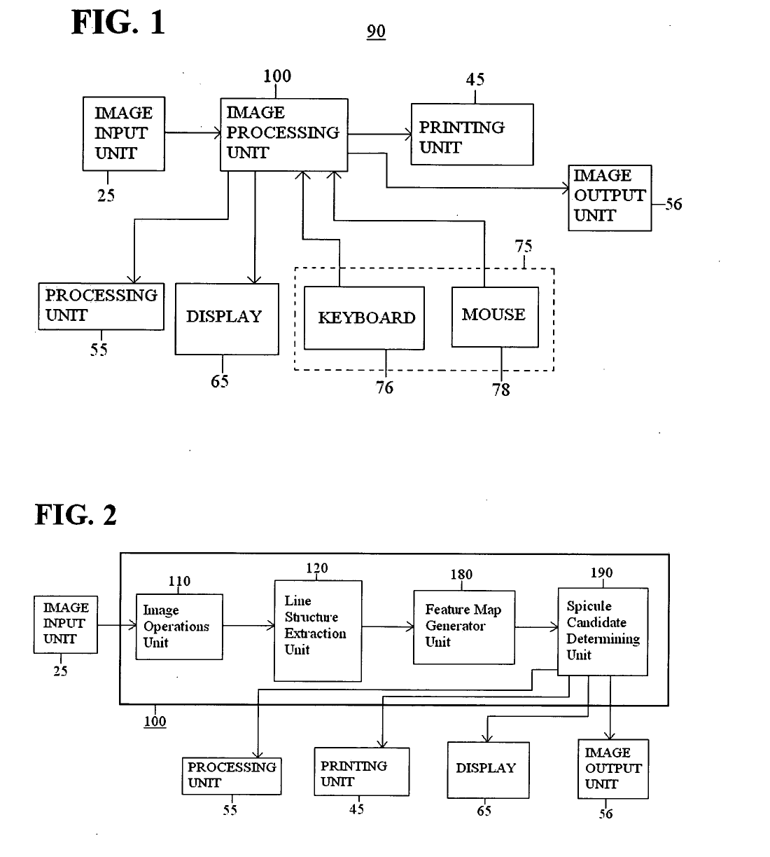

Aspects of the invention are more specifically set forth in the accompanying description with reference to the appended figures. FIG. 1 is a general block diagram of a system including an image processing unit for spiculation detection according to an embodiment of the present invention. The system 90 illustrated in FIG. 1 includes the following components: an image input unit 25; an image processing unit 100; a display 65; a processing unit 55; an image output unit 56; a user input unit 75; and a printing unit 45. Operation of the system 90 in FIG. 1 will become apparent from the following discussion.

The image input unit 25 provides digital image data representing medical images. Medical images may be mammograms, X-ray images of various parts of the body, etc. Image input unit 25 may be one or more of any number of devices providing digital image data derived from a radiological film, a diagnostic image, a digital system, etc. Such an input device may be, for example, a scanner for scanning images recorded on a film; a digital camera; a digital mammography machine; a recording medium such as a CD-R, a floppy disk, a USB drive, etc.; a database system which stores images; a network connection; an image processing system that outputs digital data, such as a computer application that processes images; etc.

The image processing unit 100 receives digital image data from the image input unit 25 and performs spiculation detection in a manner discussed in detail below. A user, e.g., a radiology specialist at a medical facility, may view the output of image processing unit 100, via display 65 and may input commands to the image processing unit 100 via the user input unit 75. In the embodiment illustrated in FIG. 1, the user input unit 75 includes a keyboard 76 and a mouse 78, but other conventional input devices could also be used.

In addition to performing spiculation detection in accordance with embodiments of the present invention, the image processing unit 100 may perform additional image processing functions in accordance with commands received from the user input unit 75. The printing unit 45 receives the output of the image processing unit 100 and generates a hard copy of the processed image data. In addition or as an alternative to generating a hard copy of the output of the image processing unit 100, the processed image data may be returned as an image file, e.g., via a portable recording medium or via a network (not shown). The output of image processing unit 100 may also be sent to image output unit 56 that collects or stores image data, and/or to processing unit 55 that performs further operations on image data, or uses image data for various purposes. The processing unit 55 may be another image processing unit; a pattern recognition unit; an artificial intelligence unit; a classifier module; an application that compares images; etc.

FIG. 2 is a block diagram illustrating in more detail aspects of the image processing unit 100 for spiculation detection according to an embodiment of the present invention. As shown in FIG. 2, the image processing unit 100 according to this embodiment includes: an image operations unit 110; a line structure extraction unit 120; a feature map generator unit 180; and a spicule candidate determining unit 190. Although the various components of FIG. 2 are illustrated as discrete elements, such an illustration is for ease of explanation and it should be recognized that certain operations of the various components may be performed by the same physical device, e.g., by one or more microprocessors.

Operation of image processing unit 100 will be next described in the context of mammography images, for detecting spiculation structures, which are a strong indicator of malignant masses. However, the principles of the current invention apply equally to other areas of medical image processing, for spiculation detection in other types of anatomical objects besides breasts.

Generally, the arrangement of elements for the image processing unit 100 illustrated in FIG. 2 performs preprocessing and preparation of digital image data including a breast image, extraction of line structures in the breast image, generation of a feature map for the breast image, and identification of spiculation structures in the breast image using the features in the feature map. Image operations unit 110 receives a breast image from image input unit 25 and may perform preprocessing and preparation operations on the breast image. Preprocessing and preparation operations performed by image operations unit 110 may include resizing, cropping, compression, color correction, noise reduction, etc., that change size and/or appearance of the breast image.

Image operations unit 110 sends the preprocessed breast image to line structure extraction unit 120, which identifies line structures in the breast image. Feature map generator unit 180 receives at least two images, including a line intensity image and a line orientation image, and calculates spicule features for areas including line structures. Spicule candidate determining unit 190 uses the spicule features to determine if various line structures are spiculation structures. Finally, spicule candidate determining unit 190 outputs a breast image with identified spiculation structures, including spicule candidates and their spicule feature values.

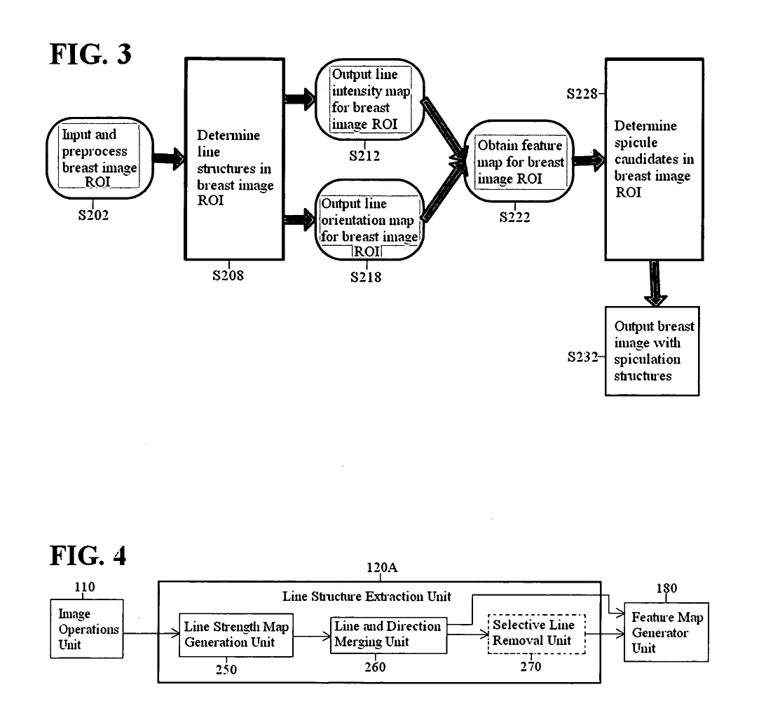

Spicule candidate and spicule feature maps output from spicule candidate determining unit 190 may be sent to processing unit 55, image output unit 56, printing unit 45, and/or display 65. Processing unit 55 may be another image processing unit, or a pattern recognition or artificial intelligence unit, used for further processing. For example, in one implementation, spiculation candidate locations and their spiculation feature values, output from spicule candidate determining unit 19, are passed to a final mass classifier that uses the spicule feature values along with other features for characterizing masses. Operation of the components included in the image processing unit 100 illustrated in FIG. 2 will be next described with reference to FIGS. 3-11.

Image operations unit 110, line structure extraction unit 120, feature map generator unit 180, and spicule candidate determining unit 190 are software systems/applications. Image operations unit 110, line structure extraction unit 120, feature map generator unit 180, and spicule candidate determining unit 190 may also be purpose built hardware such as FPGA, ASIC, etc.

FIG. 3 is a flow diagram illustrating operations performed by an image processing unit 100 for spiculation detection according to an embodiment of the present invention illustrated in FIG. 2. Image operations unit 110 receives a raw or a preprocessed breast image from image input unit 25, and may perform preprocessing operations on the breast image (S202). Preprocessing operations may include extracting a region of interest (ROI) from the breast image. If no ROI is extracted from the breast image, then the whole breast image is further used, which is equivalent to using an ROI equal to the breast image itself. Hence, from now on, the term breast image ROI is used to signify either a portion of a breast image, or the whole breast image.

The breast image ROI is sent to line structure extraction unit 120. Line structure extraction unit 120 determines line structures in the breast image ROI (S208), and outputs a line intensity map for the breast image ROI (S212) and a line orientation map for the breast image ROI (S218). Feature map generator unit 180 receives the line intensity map and the line orientation map for the breast image ROI, and obtains a feature map for the breast image ROI (S222). Spicule candidate determining unit 190 receives the feature map for the breast image ROI and determines spicule candidates in the breast image ROI (S228). Finally, spicule candidate determining unit 190 outputs a breast image with identified spiculation structures (S232).

FIG. 4 is a block diagram illustrating an exemplary line structure extraction unit 120A included in an image processing unit 100 for spiculation detection according to an embodiment of the present invention illustrated in FIG. 2. As illustrated in FIG. 4, a line structure extraction unit 120A includes: a line strength map generation unit 250; a line and direction merging unit 260; and an optional selective line removal unit 270. Line strength map generation unit 250 extracts line strengths and orientations for lines, at various scales in breast images ROIs. Line and direction merging unit 260 merges line strengths and line orientations for multiple scales into a breast line image identifying lines in the breast images ROIs. Optional selective line removal unit 270 removes from breast line images some lines that are likely to produce false spicule candidates.

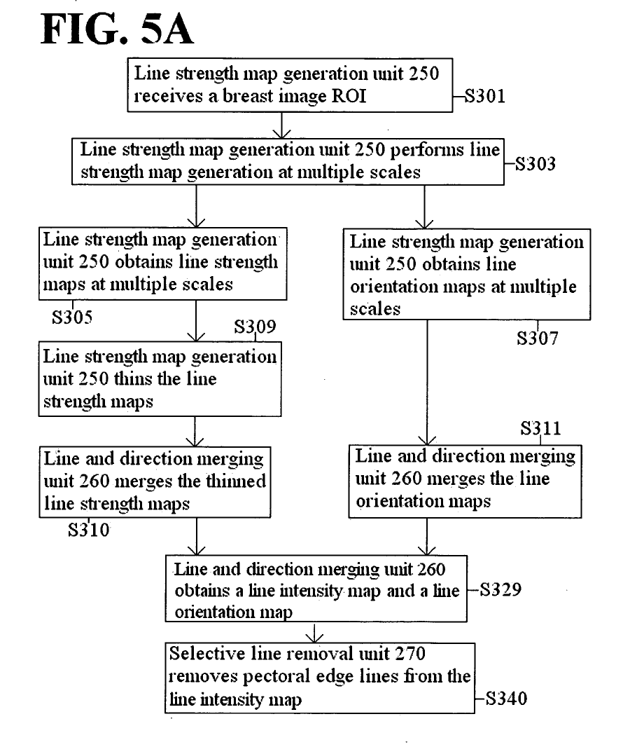

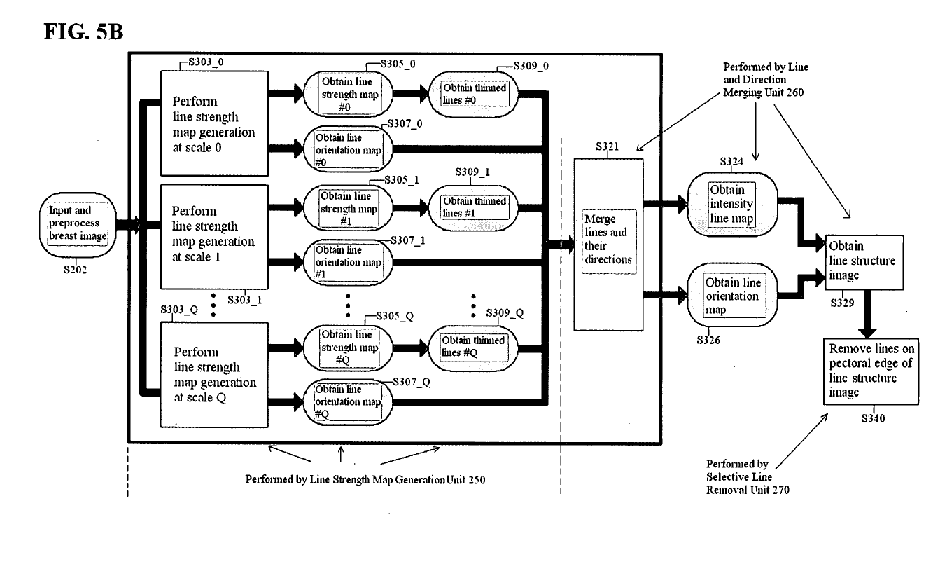

FIG. 5A is a flow diagram illustrating operations performed by an exemplary line structure extraction unit 120A included in an image processing unit 100 for spiculation detection according to an embodiment of the present invention illustrated in FIG. 4. As illustrated in FIG. 5A, line strength map generation unit 250 receives a breast image ROI (S301) and performs line strength map generation at multiple scales (S303). Line strength map generation unit 250 obtains line strength maps (S305) and line orientation maps (S307) at multiple scales, and then thins the line strength maps (S309). Line and direction merging unit 260 receives the thinned line strength maps and the line orientation maps at multiple scales, and merges the thinned line strength maps (S310) and the line orientation maps (S311), to obtain a line intensity map and a line orientation map (S329). The selective line removal unit 270 receives the line intensity map and removes pectoral edge lines from it (S340), to obtain a line intensity map without pectoral edge artifacts.

FIG. 5B is a flow diagram illustrating details of operations performed by exemplary line structure extraction unit 120A included in an image processing unit 100 for spiculation detection according to an embodiment of the present invention illustrated in FIG. 5A. The performance of spicular detection depends heavily on the performance of line structure extraction. Spiculation detection is unreliable and difficult if extracted line structures are not good enough.

Spiculated lines typically have various widths. The width of spiculated lines can be characterized by a scale parameter σ. For each scale parameter σ, line structure extraction unit 120A extracts a line strength and a line orientation at pixels inside a breast image ROI. Line structures are extracted by examining the maximum filtering response with a line-like kernel. High correlation with a target shape pattern—a line, in the current case—is considered to indicate high probability for the presence of the target (i.e., a line).

A filter method described in “Detection of Stellate Distortions in Mammograms”, by N. Karssemeijer and G. M. te Brake, IEEE Transactions on Medical Imaging, Vol. 15, No. 5, October 1996, p. 611-619, the entire contents of which are hereby incorporated by reference, may be used. For this purpose, the second directional derivative of Gaussian distribution is used as a line kernel. Other line kernels and distributions may also be used.

A line strength map L_{σ} and a line orientation map Θ_{σ} are computed by taking the maximum of the convolution of a breast image ROI and the kernel, over various angles. σ is the scale parameter that controls the line width to be detected and hence, sets the scale for line structure analysis.

Using techniques described in “Detection of Stellate Distortions in Mammograms”, by N. Karssemeijer and G. M. te Brake, IEEE Transactions on Medical Imaging, Vol. 15, No. 5, October 1996, p. 611-619, the entire contents of which are hereby incorporated by reference, the line strength and orientation at pixels inside a mammography image can be computed as illustrated below. More precisely, at a pixel at position (x,y) in the breast image ROI, the line strength and line orientation at scale σ are obtained by formulas (1) and (2):

$$\begin{matrix}{L}_{σ} ( x , y ) = {max}_{θ} [ ( I * {K}_{σ , θ} ) ( x , y ) ] & ( 1 ) \\ {Θ}_{σ} ( x , y ) = {arg max}_{θ} [ ( I * {K}_{σ , θ} ) ( x , y ) ] & ( 2 )\end{matrix}$$

where I is the original breast image ROI, * is the 2-D convolution operator, and K_{σ,θ} is the second directional derivative at angle θ of Gaussian kernel, given by:

$${K}_{σ , θ} ( x , y ) = \frac{1}{2 {πσ}^{4}} [ \frac{{( x cos θ - y sin θ )}^{2}}{{σ}^{2}} - 1 ] exp ( - \frac{{x}^{2} + {y}^{2}}{2 {σ}^{2}} ) \qquad ( 3 )$$

### In the above formulas, the line width and angle to be detected can be adjusted by choosing appropriate values of σ and θ.

Spiculated lines typically have various widths and orientations. Line strength and line orientation may be calculated for various σ and θ using formulas (1) and (2), in order to detect various line structures forming spiculation structures. However, applying the convolution in formulas (1) and (2) for various σ and θ requires large volumes of data processing, and creates serious computational problems for practical CAD systems. To circumvent this difficulty, a multiscale approach related to the scale parameter σ is used by line structure extraction unit 120A to detect spiculated line structures.

As illustrated in FIG. 5B, image operations unit 110 inputs and preprocesses a breast image, and outputs a breast image ROI (S202). To detect spiculated lines of various widths, the scale parameter σ is varied according to the widths of the spiculated lines to be detected. Line structure extraction unit 120A applies a multiscale approach for this purpose. Line strength map generation unit 250 applies a line extraction method, for scales 0, 1, . . . Q, by using various σ's (S303_0, S303_1, . . . , S303_Q), to obtain line strength maps L_{σ}(x, y) (S305_0, S305_1, . . . , S305_Q), and line orientation maps Θ_{σ}(x, y) (S307_0, S307_1, . . . , S307_Q) for points (x,y) inside the breast image ROI. Line and direction merging unit 260 receives the line strength maps and the line orientation maps. Line and direction merging unit 260 consolidates the line strength maps and the line orientation maps over the various analyzed scales (S321). For this purpose, line and direction merging unit 260 consolidates the line strength maps into one line intensity map (S324), and the line orientation maps into one line orientation map (S326). Hence, two output images are generated: one line orientation map and one line intensity map. The line orientation at a line intensity map pixel is given by the corresponding pixel in the line orientation map.

To obtain the final line strength map in step S324, each pixel in the final line strength map is set to the maximum of line strength over scales. For example, if pixel P1 has line strength L_{σ0}(x, y) in the line strength map at scale 0 at step S305_0 (where σ0 is the scale parameter associated with scale 0), line strength L_{σ1}(x, y) in the line strength map at scale 1 at step S305_1 (where σ1 is the scale parameter associated with scale 1), . . . , line strength L_{σQ}(x, y) in the line strength map at scale Q at step S305_Q (where σQ is the scale parameter associated with scale Q), then pixel P1 is set to have line strength=max(L_{σ0}(x, y), L_{σ1}(x, y), . . . , L_{σQ}(x, y)) in the final line strength map at step S324. The line strength map is also called line intensity map in the current application.

To obtain the final line orientation map in step S326, the line orientation of each pixel in the final line orientation map is set to the line orientation at the scale where the line strength yields maximum over scales. For example, if pixel P1 has line strength L_{σ0}(x, y) in the line strength map at scale 0 at step S305_0, line strength L_{σ1}(x, y) in the line strength map at scale 1 at step S305_1, . . . , line strength L_{σQ}(x, y) in the line strength map at scale Q at step S305_Q, and maximum pixel line strength for pixel P1, equal to max(L_{σ0}(x, y), L_{σ1}(x, y), . . . , L_{σQ}(x, y)), occurs at scale j, 0≦j≦Q, then the line orientation of pixel P1 in the final line orientation map in step S326 is set to be the line orientation Θ_{σj}(x, y) at the scale j, as obtained in a step S305_j.

Line and direction merging unit 260 next obtains a line structure image, using data from the intensity line map and the line orientation map (S329). The line structure image obtained in step S329 may be a breast image with identified lines throughout the breast image. Selective line removal unit 270 receives the line structure image. Since the line extraction algorithm often yields strong response on the breast pectoral edge, false spicule candidates may be identified on the pectoral edge. To reduce this type of false spicule candidates, selective line removal unit 270 removes lines on pectoral edge (S340). The pectoral edge of breasts may be determined manually, or using automated pectoral edge detection techniques.

Pectoral edge line removal may be performed before or after the line intensity and line orientation maps are combined to obtain the line structure image.

Before obtaining the final line strength map and final line orientation map in steps S324 and S326, from line strength maps L_{σ}(x, y) for scales 0, 1, . . . , Q, thinned line maps may be obtained. For example, a thinned line map L_{σ0}_{_{—}}_{thinned}(x, y) for scale 0 can be obtained in step S309_0, from line strength map L_{σ0}(x, y) for scale 0, a thinned line map L_{σ1}_{_{—}}_{thinned}(x, y) for scale 1 can be obtained in step S309_1, from line strength map L_{σ1}(x, y) for scale 1, . . . , and a thinned line map L_{σQ}_{_{—}}_{thinned}(x, y) for scale Q can be obtained in step S309_Q, from line strength map L_{σQ}(x, y) for scale Q. Any existent thinning algorithms may be used to obtain the thinned line maps. The thinned line maps L_{σ0}_{_{—}}_{thinned}(x, y), L_{σ1}_{_{—}}_{thinned}(x, y), . . . , L_{σQ}_{_{—}}_{thinned}(x, y) can then be used instead of the line strength maps L_{σ0}(x, y), L_{σ1}(x, y), and L_{σQ}(x, y), to obtain the final line strength map and the final line orientation map in steps S324 and S326. Using the thinned line maps L_{σ0}_{_{—}}_{thinned}(x, y), L_{σ1}_{_{—}}_{thinned}(x, y), . . . , L_{σQ}_{_{—}}_{thinned}(x, y) instead of the line strength maps L_{σ0}(x, y), L_{σ1}(x, y), and L_{σQ}(x, y) improves line detection ratio, as line orientation estimation is more accurate when line pixels with low line intensity are excluded.

In an exemplary implementation, thinning is performed by applying binarization and then a morphological method.

Instead of thinning, line strength maps may be only thresholded. Like thinning, thresholding makes line orientation estimation more accurate by excluding line pixels with low line intensity.

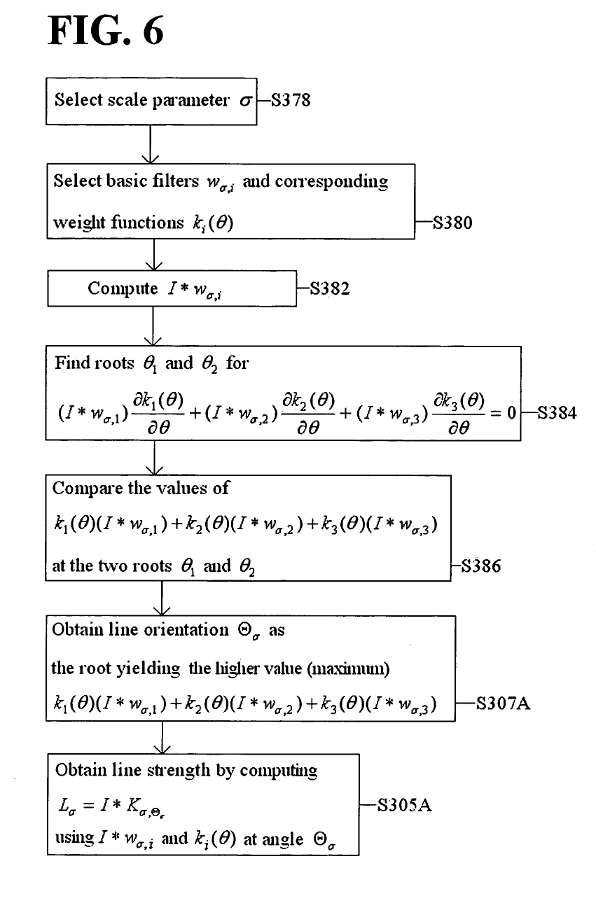

FIG. 6 is a flow diagram illustrating operations performed by a line strength map generation unit 250 included in a line structure extraction unit 120A, for multiscale line structure extraction using steerable filters according to an embodiment of the present invention illustrated in FIGS. 5A and 5B. FIG. 6 illustrates a technique for efficiently obtaining line strengths L_{σ}(x, y) and line orientations Θ_{σ}(x, y) for points inside a breast image ROI.

As shown by formulas (1) and (2), given a scale parameter σ, the convolution I*K_{σ,θ} for various angles θ needs to be computed, to obtain Θ_{σ}(x, y) and L_{σ}(x, y). Calculating the convolution I*K_{σ,θ} for various angles θ is computationally burdensome, and hard to implement in a practical real-time automated system.

A computationally efficient alternative is to apply a steerable filter method, so that the convolution I*K_{σ,θ} is not computed for multiple angles θ by brute force. Steerable filters are “a class of filters in which a filter of arbitrary orientation is synthesized as a linear combination of a set of ‘basic filters’ ”, as described in “The Design and Use of Steerable Filters”, by W. T. Freeman and E. H. Adelson, IEEE Transactions on Pattern Analysis and Machine Intelligence, Vol. 13, No. 9, September 1991, p. 891-906, the entire contents of which are hereby incorporated by reference. The basic filters can be selected to be independent of orientation θ, while the weight functions used in the linear combination of basic filters depend on θ only. It is known that K_{σ,θ} can be represented with only three basic filters, as demonstrated in “Generic Neighborhood Operators”, by J. J. Koenderink and A. J. van Doom, IEEE Transactions on Pattern Analysis and Machine Intelligence, vol 14, pp. 597-605, 1992, “The Design and Use of Steerable Filters”, by W. T. Freeman and E. H. Adelson, IEEE Transactions on Pattern Analysis and Machine Intelligence, Vol. 13, No. 9, September 1991, p. 891-906, and/or “Detection of Stellate Distortions in Mammograms”, by N. Karssemeijer and G. M. te Brake, IEEE Transactions on Medical Imaging, Vol. 15, No. 5, October 1996, p. 611-619, the entire contents of these three publications being hereby incorporated by reference. Hence, K_{σ,θ} can be represented with only three basic filters as shown in equation (4) below:

$${K}_{σ , θ} ( x , y ) = \frac{1}{2 {πσ}^{4}} [ {k}_{1} ( θ ) {w}_{σ , 1} ( x , y ) + {k}_{2} ( θ ) {w}_{σ , 2} ( x , y ) + {k}_{3} ( θ ) {w}_{σ , 3} ( x , y ) ] \qquad ( 4 )$$

where w_{σ,i}(.,.) is the i-th basic filter and kᵢ(θ) is its corresponding weight function.

Then, by the linearity of convolution, I*K_{σ,θ} can be computed by:

$$I * {K}_{σ , θ} = \frac{1}{2 {πσ}^{4}} [ {k}_{1} ( θ ) ( I * {w}_{σ , 1} ) + {k}_{2} ( θ ) ( I * {w}_{σ , 2} ) + {k}_{3} ( θ ) ( I * {w}_{σ , 3} ) ] \qquad ( 5 )$$

### Since

$${L}_{σ} ( x , y ) = {max}_{θ} [ ( I * {K}_{σ , θ} ) ( x , y ) ]$$

$$and$$

$${Θ}_{σ} ( x , y ) = {arg max}_{θ} [ ( I * {K}_{σ , θ} ) ( x , y ) ]$$

from formulas (1) and (2), only the θ and L_{σ} for the extremum filtering response I*K_{σ,θ} are needed. Hence, I*K_{σ,θ} does not need to be computed for all angles, as it is enough to examine only the orientations (i.e. angles θ) that satisfy

$$\frac{\partial }{\partial θ} ( I * {K}_{σ , θ} ) = 0.$$

### Using equation (5), the relationship

$$\frac{\partial }{\partial θ} ( I * {K}_{σ , θ} ) = 0$$

becomes:

$$( I * {w}_{σ , 1} ) \frac{\partial {k}_{1} ( θ )}{\partial θ} + ( I * {w}_{σ , 2} ) \frac{\partial {k}_{2} ( θ )}{\partial θ} + ( I * {w}_{σ , 3} ) \frac{\partial {k}_{3} ( θ )}{\partial θ} = 0 \qquad ( 6 )$$

### The solution to equation (6) is computationally easy to find, since equation (6) poses a one-dimensional problem, for which a known closed form solution is available.

Hence, to find the line strength

$${L}_{σ} ( x , y ) = {max}_{θ} [ ( I * {K}_{σ , θ} ) ( x , y ) ]$$

and the line orientation

$${Θ}_{σ} ( x , y ) = {arg max}_{θ} [ ( I * {K}_{σ , θ} ) ( x , y ) ]$$

for scale parameter σ, given basic filters w_{σ,i} and corresponding weight functions kᵢ(θ), i=1, 2, 3 (S380), line strength map generation unit 250 computes I*w_{σ,i}, i=1, 2, 3 (S382); finds roots θ₁ and θ₂ for

$$( I * {w}_{σ , 1} ) \frac{\partial {k}_{1} ( θ )}{\partial θ} + ( I * {w}_{σ , 2} ) \frac{\partial {k}_{2} ( θ )}{\partial θ} + ( I * {w}_{σ , 3} ) \frac{\partial {k}_{3} ( θ )}{\partial θ} = 0 ( S 384 ) ;$$

compares the values of k₁(θ)(I*w_{σ,1})+k₂(θ)(I*w_{σ,2})+k₃(θ)(I*w_{σ,3}) at the two roots θ₁ and θ₂ (S386); selects the root yielding the higher value for k₁(θ)(I*w_{σ,1})+k₂(θ)(I*w_{σ,2})+k₃(θ)(I*w_{σ,3}) to be the line orientation Θ_{σ} (S307A); and obtains the line strength L_{σ}=I*K_{σ,Θ}_{_{σ}} at angle Θ_{σ} using I*w_{σ,i} and kᵢ(θ) at angle Θ_{σ} (S305A).

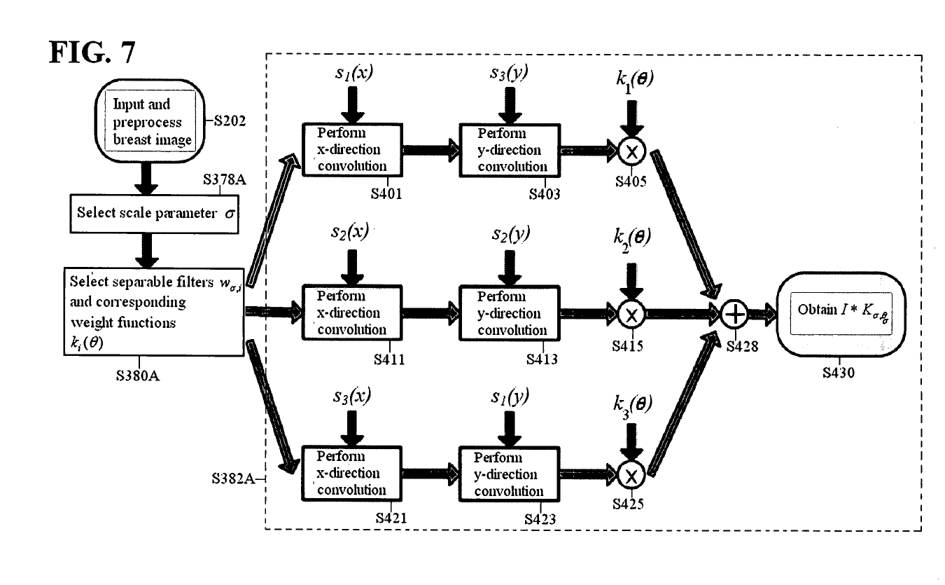

FIG. 7 is a flow diagram illustrating operations performed by a line strength map generation unit 250 included in a line structure extraction unit 120A, for performing convolution operations using separable basic kernels to obtain line strength and orientation according to an embodiment of the present invention illustrated in FIG. 6. FIG. 7 describes an exemplary implementation for step S382 of FIG. 6 and to obtain line strength at step S305A in FIG. 6.

There are many choices for the basic filters w_{σ,i} and weight functions kᵢ(θ) for K_{σ,θ} expressed in formula (4). For example, basic filters w_{σ,i}=K_{σ,iπ/3}, i=1, 2, 3 were used in “Detection of Stellate Distortions in Mammograms”, by N. Karssemeijer and G. M. te Brake, IEEE Transactions on Medical Imaging, Vol. 15, No. 5, October 1996, p. 611-619, the entire contents of which are hereby incorporated by reference. Using these basic filters w_{σ,i} is still computationally burdensome, because the 2-D convolution operations in I*w_{σ,i} are computationally expensive, since K_{σ,π/3} and K_{σ,2π/3} are not separable for the directions π/3 and 2π/3. Moreover, the 2-D convolution operations in I*w_{σ,i} are even more computationally expensive for larger σ.

To decrease computational complexity, the following basic filters and weight functions can be chosen to represent K_{σ,θ}:

$$\begin{matrix}{w}_{σ , 1} ( x , y ) = [ \frac{{x}^{2}}{{σ}^{2}} - 1 ] exp ( - \frac{{x}^{2} + {y}^{2}}{2 {σ}^{2}} ) & ( 7 ) \\ {w}_{σ , 2} ( x , y ) = [ \frac{xy}{{σ}^{2}} ] exp ( - \frac{{x}^{2} + {y}^{2}}{2 {σ}^{2}} ) & ( 8 ) \\ {w}_{σ , 3} ( x , y ) = [ \frac{{y}^{2}}{{σ}^{2}} - 1 ] exp ( - \frac{{x}^{2} + {y}^{2}}{2 {σ}^{2}} ) & ( 9 )\end{matrix}$$

k₁(θ)=cos² θ (10)

k₂(θ)=−2 cos θsin θ (11)

k₃(θ)=sin² θ (12)

The basic filters w_{σ,i} can then be represented as separable filters as illustrated in equations (13), (14), (15), (16), (17), (18) below:

w_{σ,1}(x,y)=s₁(x)s₃(y) (13)

w_{σ,2}(x,y)=s₂(x)s₂(y) (14)

w_{σ,3}(x,y)=s₃(x)s₁(y) (15)

where

$$\begin{matrix}{s}_{1} ( t ) = ( \frac{{t}^{2}}{{σ}^{2}} - 1 ) exp ( - \frac{{t}^{2}}{2 {σ}^{2}} ) & ( 16 ) \\ {s}_{2} ( t ) = \frac{t}{σ} exp ( - \frac{{t}^{2}}{2 {σ}^{2}} ) & ( 17 ) \\ {s}_{3} ( t ) = exp ( - \frac{{t}^{2}}{2 {σ}^{2}} ) & ( 18 )\end{matrix}$$

This choice of basic filters has been described in “The Design and Use of Steerable Filters”, by W. T. Freeman and E. H. Adelson, IEEE Transactions on Pattern Analysis and Machine Intelligence, Vol. 13, No. 9, September 1991, p. 891-906, the entire contents of which are hereby incorporated by reference. By using the separable filters described in equations (13), (14), (15), (16), (17), (18) the 2-D filtering step S382 in the flow diagram of FIG. 6 can be performed by successive 1-D filtering in the x- and y-directions.

For this purpose, for a scale parameter σ (S378A), separable filters w_{σ,i} and corresponding weight functions kᵢ(θ), i=1, 2, 3 are selected based on equations (13), (14), (15), (16), (17), (18) (S380A), as illustrated in the flow diagram of FIG. 7. Using the separability of the filters, x-direction convolutions and y-direction convolutions are performed to obtain I*w_{σ,1} (S401, S403), I*w_{σ,2} (S411, S413), and I*w_{σ,3} (S421, S423).

For angle Θ_{σ} obtained in step S307A in FIG. 6, multiplication by the corresponding weight functions kᵢ(θ), i=1, 2, 3 is performed to obtain k₁(θ)(I*w_{σ,1}) (S405), k₂(θ)(I*w_{σ,2}) (S415), and k₃(θ)(I*w_{σ,3}) (S425). The results of steps S405, S415 and S425 are added (S428) to obtain the line strength map I*K_{σ,74} at angle θ=Θ_{σ}, as

$$I * {K}_{σ , θ} = \frac{1}{2 π {σ}^{4}} [ {k}_{1} ( θ ) ( I * {w}_{σ , 1} ) + {k}_{2} ( θ ) ( I * {w}_{σ , 2} ) + {k}_{3} ( θ ) ( I * {w}_{σ , 3} ) ] ,$$

as described in equation (5).

In this manner, the line strength map at angle θ=Θ_{σ}(x, y) can be computed efficiently for each pixel position (x,y). The separability of the representations using the basic filters reduces computation per pixel from N̂2 to 2N, hence providing a N/2 speedup, where N is the width or height of 2-D filtering kernel.

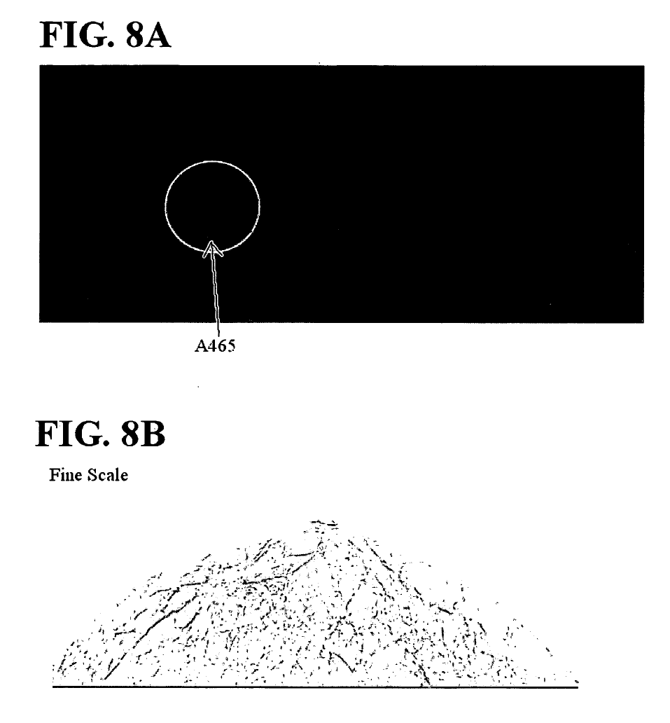

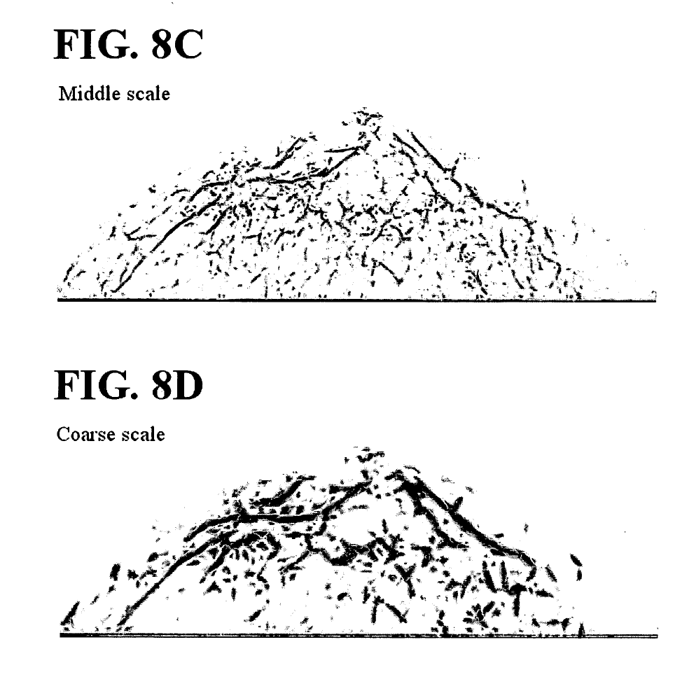

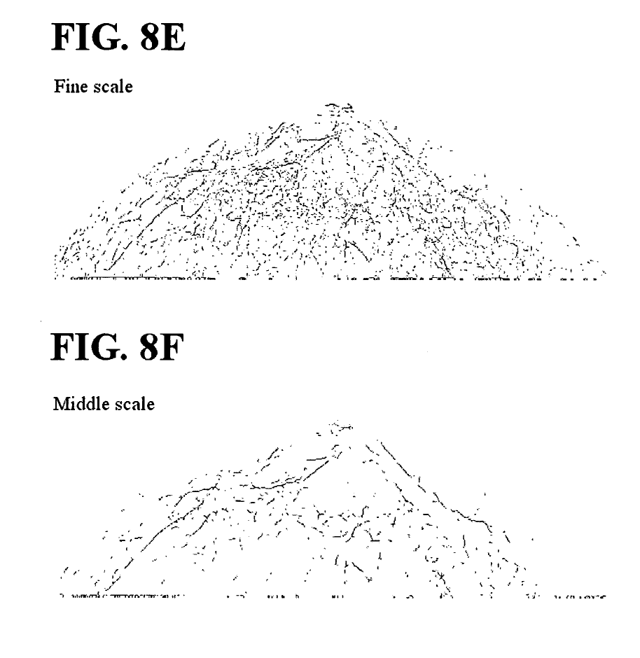

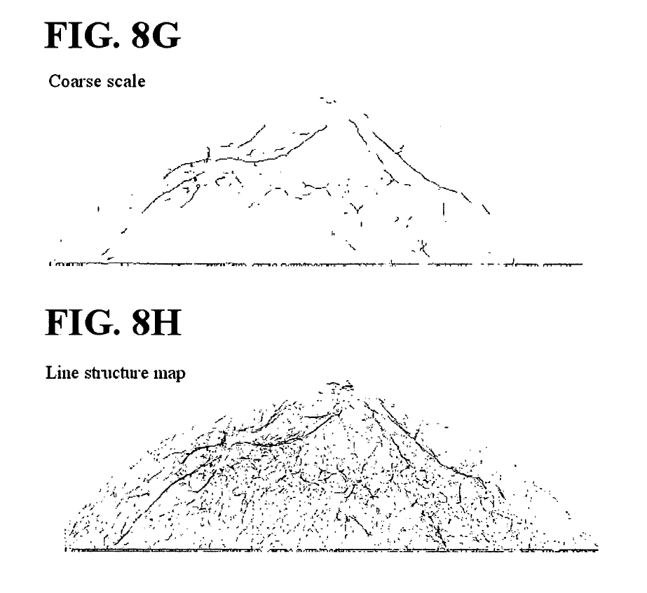

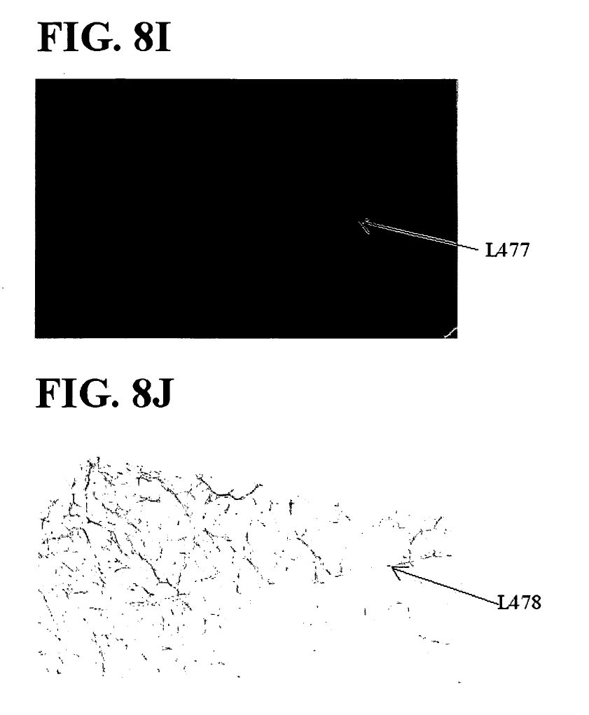

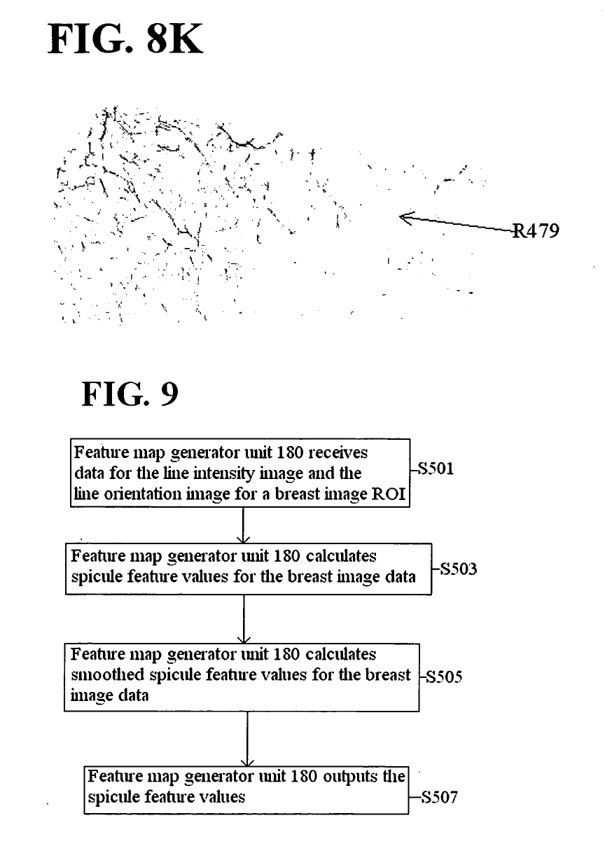

FIG. 8A illustrates an exemplary breast image including a spiculation structure. The encircled area A465 contains a spiculation structure. FIG. 8B illustrates a fine scale line strength map obtained for the breast image in FIG. 8A by line strength map generation unit 250 in a step S305_i, where 0≦i≦Q, according to an embodiment of the present invention illustrated in FIG. 5B. FIG. 8C illustrates a middle scale line strength map for the breast image in FIG. 8A, obtained by line strength map generation unit 250 in a step S305_j, where 0≦j≦Q, i≠j, according to an embodiment of the present invention illustrated in FIG. 5B. FIG. 8D illustrates a coarse scale line strength map for the breast image in FIG. 8A, obtained by line strength map generation unit 250 in a step S305_k, where 0≦k≦Q, k≠i and k≠j, according to an embodiment of the present invention illustrated in FIG. 5B. FIG. 8E illustrates a fine scale thinned line strength binary map for the breast image in FIG. 8A, obtained by line strength map generation unit 250 from the fine scale line strength map in FIG. 8B, in a step S309_i, according to an embodiment of the present invention illustrated in FIG. 5B. FIG. 8F illustrates a fine scale thinned line strength binary map for the breast image in FIG. 8A, obtained by line strength map generation unit 250 from the fine scale line strength map in FIG. 8C, in a step S309_j, according to an embodiment of the present invention illustrated in FIG. 5B. FIG. 8G illustrates a fine scale thinned line strength binary map for the breast image in FIG. 8A, obtained by line strength map generation unit 250 from the fine scale line strength map in FIG. 8D, in a step S309_k, according to an embodiment of the present invention illustrated in FIG. 5B. FIG. 8H illustrates the line structure image for the breast image in FIG. 8A, obtained in step S329 by line and direction merging unit 260 from multiple scale images including images in FIGS. 8E, 8F, and 8G, according to an embodiment of the present invention illustrated in FIG. 5B.

FIG. 8I illustrates another exemplary breast image. The line L477 represents the pectoral edge of the breast image. FIG. 8J illustrates the line structure image obtained by line and direction merging unit 260 for the breast image in FIG. 8I, before pectoral edge removal, according to an embodiment of the present invention illustrated in FIG. 5B. The line structure image includes lines on the breast pectoral edge, such as line L478. Such pectoral edge lines lead to identification of false spicule candidates at the pectoral edge. FIG. 8K illustrates the line structure image obtained by selective line removal unit 270 for the breast image in FIG. 8I, after pectoral edge removal, according to an embodiment of the present invention illustrated in FIG. 5B. Lines were removed from the pectoral edge in region R479, for example.

FIG. 9 is a flow diagram illustrating operations performed by a feature map generator unit 180 included in an image processing unit 100 for spiculation detection according to an embodiment of the present invention illustrated in FIG. 2. The feature map generator unit 180 receives data for the line intensity image and the line orientation image for a breast image ROI (S501), and calculates spicule feature values for the breast image data (S503), as well as smoothed spicule feature values for the breast image data (S505). The spicule feature values are computed based on line structure in the line structure images including the line intensity image and the line orientation image. The feature map generator unit 180 then outputs the spicule feature values (S507).

In one exemplary embodiment, 10 spicule feature values are calculated for line structure images including line intensity images and line orientation images.

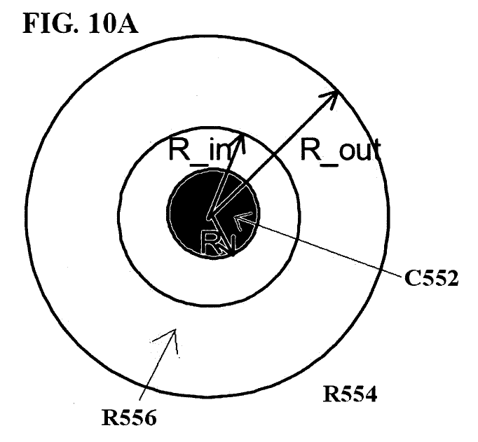

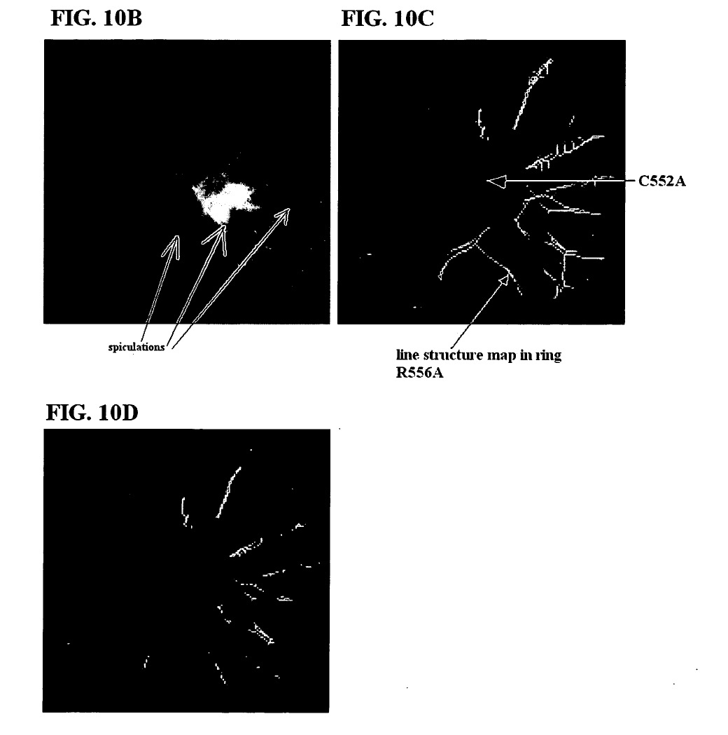

FIG. 10A illustrates aspects of the operation of calculating spiculation features by a feature map generator unit 180 included in an image processing unit 100 for spiculation detection according to an embodiment of the present invention illustrated in FIG. 9. A line concentration feature may be calculated by feature map generator unit 180 in step S503 in FIG. 9.

The line concentration feature measure calculated by feature map generator unit 180 is similar to a feature developed in “Detection of Stellate Distortions in Mammograms”, by N. Karssemeijer and G. M. te Brake, IEEE Transactions on Medical Imaging, Vol. 15, No. 5, October 1996, p. 611-619, the entire contents of which are hereby incorporated by reference. For each pixel i of interest in a breast image ROI, let Aᵢ be the set of the line pixels in the gray ring R556, and S, be the set of pixels that belong to Aᵢ and point to the center circle C552. The gray ring R556 has pixel i as center, inner radius R_in, and outer radius R_out, and the center circle C552 has pixel i as center, and radius R. Let Nᵢ be the number of pixels in Sᵢ. Suppose that Kᵢ is its corresponding random variable, which is the number of pixels that belong to Aᵢ and point to the center circle C552. That is, Nᵢ is a realization of the random variable Kᵢ. Assuming that line orientation is uniformly distributed, the expectation and standard deviation of Kᵢ are computed. The line concentration feature measure is a statistic defined by equation (19):

$${f}_{i , 1} = \frac{{N}_{i} - ( expectation of {K}_{i} )}{( standard deviation of {K}_{i} )} \qquad ( 19 )$$

### The statistics of lines generated during the calculation of the spicule concentration feature are then re-used in all other spicule features described below.

FIG. 10B illustrates an exemplary mammogram ROI image including spiculation structures. FIG. 10C illustrates a line structure map extracted for the exemplary mammogram ROI image illustrated in FIG. 10B, according to an embodiment of the present invention illustrated in FIG. 5B. The line structure map illustrated in FIG. 10C is extracted for a ring R556A for the original ROI image in FIG. 10B. FIG. 10D illustrates a map of radiating lines obtained from the line structure map illustrated in FIG. 10C, according to an embodiment of the present invention illustrated in FIG. 10A. The pixels that have a non-black color in the map of radiating lines in FIG. 10D are the set of line pixels Sᵢ in the gray ring R556A, where the line pixels point to a center circle C552A. Hence, Nᵢ is the number of pixels that are non-black in the map of radiating lines in FIG. 10D.

To compute a directional entropy feature for pixel i, the line structure maps in Sᵢ are examined. Suppose a directional entropy feature is computed based on the number of line pixels for pixel i. A histogram is generated for the angle of all radiating line pixels in Sᵢ. Let L_{i,k} be the number of pixels in the k-th bin from the angle histogram:

$${L}_{i , k} = {\sum }_{( radiating line pixels i n k \text{-} th direction bin i n {S}_{i} )} 1.$$

### A directional entropy feature is then defined by the entropy calculated based on this histogram, as expressed in equation (20):

$${f}_{i , 2} = - {\sum }_{k = 1}^{\# direction bins} \frac{{L}_{i , k}}{{N}_{i}} ln \frac{{L}_{i , k}}{{N}_{i}} . \qquad ( 20 )$$

The feature described by equation (20) is similar to the directional entropy in patent application US2004/0151357 titled “Abnormal Pattern Detecting Apparatus”, by inventors Shi Chao and Takeo Hideya, the entire contents of which are hereby incorporated by reference, but there are two important differences between the feature described by equation (20) in this disclosure and the directional entropy in patent application US2004/0151357. First, f_{i,2} is computed based on pixels only Sᵢ, while the directional entropy in US2004/0151357 was computed for Aᵢ, since there was no motivation in US2004/0151357 to consider diversity of the pixels that are not oriented to spicule center. Second, the angle histogram is computed from Θ_{σ} in a pixel-based manner, while in US2004/0151357 line directions are computed by labeling one direction for each connected line.

Another feature calculated by feature map generator unit 180 for spiculation detection is the line orientation diversity feature. To calculate the line orientation diversity feature, let n_{+,i} be the number of bins where L_{i,k} is larger than the median value calculated based on an assumption that line orientation is random. Suppose that N_{+,i} is a random variable, which is the number of bins where L_{i,k} is larger than the median value calculated based on an assumption that line orientation is random. That is, n_{+,i} is a realization of N_{+,i}. The line orientation diversity feature is then defined as

$${f}_{i , 3} = \frac{{n}_{+ , i} - ( expectation of {N}_{+ , i} )}{( standard deviation of {N}_{+ , i} )} \qquad ( 21 )$$

The line orientation diversity feature is similar to a feature developed in “Detection of Stellate Distortions in Mammograms”, by N. Karssemeijer and G. M. te Brake, IEEE Transactions on Medical Imaging, Vol. 15, No. 5, October 1996, p. 611-619, the entire contents of which are hereby incorporated by reference.

In many cases where only one or two strong lines exist in a spiculation structure, the spicule features (especially the line concentration feature and the line orientation diversity feature) have high responses and little specificity. To aid in spiculation detection in such cases, two additional linearity features are calculated by feature map generator unit 180 for spiculation detection. The two additional spicule linearity features employed are described by equations (22) and (23) below:

$$\begin{matrix}{f}_{i , 4} = 1 - \frac{{\sum }_{( radiating line pixels i n top 3 direction bins )} 1}{{\sum }_{( All radiating line pixels )} 1} \\ and & ( 22 ) \\ {f}_{i , 5} = 1 - \frac{{\sum }_{( radiating line pixels i n top 3 direction bins )} ( line intensity )}{{\sum }_{( All radiating line pixels )} ( line intensity )} . & ( 23 )\end{matrix}$$

To obtain the bins used in equations (22) and (23), directions are divided into a number of bins, and the radiating line pixels in each direction bin are then counted. The three bins that have most radiating line pixels are then chosen, to obtain the “top 3 direction bins” used in equations (22) and (23).

Feature map images are typically rough, as they are sensitive to noise and small pixel positions differences. To reduce the effect of noise, smoothed spicule features for smoothed feature images are extracted by feature map generator unit 180 for spiculation detection. The smoothed spicule features may be extracted by filtering with a smoothening filter. Five smoothed spicule features f_{i,6}, f_{i,7}, f_{i,8}, f_{i,9}, f_{i,10} are calculated. The five smoothed spicule features are obtained by smoothing the five features f_{i,1}, f_{i,2}, f_{i,3}, f_{i,4}, f_{i,5} described by equations (19), (20), (21), (22), and (23).

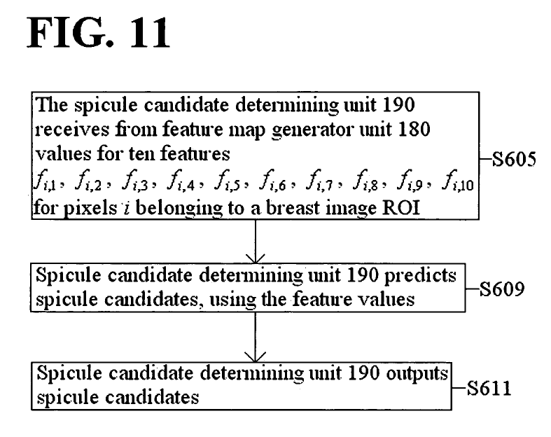

FIG. 11 is a flow diagram illustrating operations performed by a spicule candidate determining unit 190 included in an image processing unit 100 for spiculation detection according to an embodiment of the present invention illustrated in FIG. 2. The spicule candidate determining unit 190 receives from feature map generator unit 180 values for ten features f_{i,1}, f_{i,2}, f_{i,3}, f_{i,4}, f_{i,5}, f_{i,6}, f_{i,7}, f_{i,8}, f_{i,9}, f_{i,10}, for pixels i belonging to a breast image ROI (S605). Spicule candidate determining unit 190 then predicts spicule candidates, using the feature values (S609) and outputs spicule candidates (S611). Spicule candidate determining unit 190 may use an SVM predictor to predict spicule candidates. The SVM predictor is trained offline, using sets of breast images with identified spicule structures.

More or fewer than 10 features may also be used to detect spiculated structures.

In an exemplary embodiment using the 10 spicule feature values f_{i,1}, f_{i,2}, f_{i,3}, f_{i,4}, f_{i,5}, f_{i,6}, f_{i,7}, f_{i,8}, f_{i,9}, f_{i,10}, for pixels i belonging to breast image ROIs, an SVM predictor uses 10 features f_{i,2} f_{i,3}, f_{i,4}, f_{i,5}, f_{i,6}, f_{i,7}, f_{i,8}, f_{i,9}, f_{i,10} (or more or less features, depending on availability) as an input vector, and calculates an SVM prediction score as a final spiculation feature.

In one exemplary embodiment, the SVM predictor picks two spicule candidates based on SVM scores. In order to avoid duplicated candidates in one breast region, two spicule candidates may be chosen so that they are spatially sufficiently apart from each other.

Using SVM prediction scores as final features for spicule identification improves performance by offering flexibility in the decision boundary. The spiculation detection methods and apparatuses presented in this application are more accurate than the typical/conventional spiculation detection algorithms, and computationally more efficient compared to spiculation detection algorithms presented in “Detection of Stellate Distortions in Mammograms”, by N. Karssemeijer and G. M. te Brake, IEEE Transactions on Medical Imaging, Vol. 15, No. 5, October 1996, p. 611-619. Thus, the advantages of the present invention are readily apparent.

The methods and apparatuses described in the current application detect spiculation structures and enable detection of cancer masses. The methods and apparatuses described in the current application are automatic and can be used in computer-aided detection of cancer in breasts. The methods and apparatuses described in the current application can be used to detect spiculation structures and malignant masses in other anatomical parts besides breasts. For example, methods and apparatuses described in the current application can be used to detect spiculation structures and malignant masses in lung cancer.

Although detailed embodiments and implementations of the present invention have been described above, it should be apparent that various modifications are possible without departing from the spirit and scope of the present invention.

I claim:

1. An image processing method for identifying a spicule candidate in a medical image, said method comprising:
accessing digital image data representing an image including a tissue region;
processing said digital image data by generating at least one line orientation map and at least one line strength map for said tissue region for at least one scale, using separable filters;
calculating spicule feature values based on said at least one line orientation map and said at least one line strength map; and
identifying a spicule candidate based on said calculated features values.

2. The image processing method as recited in claim 1, wherein said step of processing said digital image data to generate said at least one line strength map for said tissue region computes line strength at angle θ by performing successive one-dimensional filtering in the x-direction and the y-direction.

3. The image processing method according to claim 2, wherein said separable filters are represented by:
$$\begin{matrix}{w}_{σ , 1} ( x , y ) = [ \frac{{x}^{2}}{{σ}^{2}} - 1 ] exp ( - \frac{{x}^{2} + {y}^{2}}{2 {σ}^{2}} ) \\ {w}_{σ , 2} ( x , y ) = [ \frac{xy}{{σ}^{2}} ] exp ( - \frac{{x}^{2} + {y}^{2}}{2 {σ}^{2}} ) \\ {w}_{σ , 3} ( x , y ) = [ \frac{{y}^{2}}{{σ}^{2}} - 1 ] exp ( - \frac{{x}^{2} + {y}^{2}}{2 {σ}^{2}} )\end{matrix}$$
wherein σ is s scale parameter.

4. The image processing method according to claim 1, wherein said separable filters are steerable filters.

5. The image processing method as recited in claim 1, further comprising:
thinning said at least one line strength map before said calculating step.

6. The image processing method as recited in claim 1, wherein said step of calculating spicule feature values includes calculating, for each of a plurality of pixels of interest, at least one of a line concentration measure, a directional entropy measure, a line orientation diversity measure, and a linearity measure, using said at least one line orientation map and said at least one line strength map.

7. The image processing method as recited in claim 6, wherein said linearity measure is a weighted feature as a function of line intensity.

8. The image processing method as recited in claim 1, further comprising:
smoothing said spicule feature values.

9. The image processing method as recited in claim 8, wherein said step of identifying a spicule candidate identifies a spicule candidate using said calculated spicule features values and said smoothed spicule feature values.

10. The image processing method as recited in claim 1, further comprising:
removing pectoral edge lines from said at least one line strength map.

11. The image processing method as recited in claim 1, further comprising:
merging said at least one line orientation map and said at least one line strength map for said at least one scale to obtain a line structure map, wherein said at least one scale includes at least two scales, and wherein said line structure map is used by said calculating step.

12. The image processing method as recited in claim 1, wherein said identifying step uses a Support Vector Machine classifier to detect a spicule candidate based on said calculated features values.

13. The image processing method as recited in claim 1, wherein said tissue region is included in a breast region.

14. An image processing apparatus for identifying a spicule candidate in a medical image, said apparatus comprising:
an image data input unit for accessing digital image data representing an image including a tissue region;
a line structure extraction unit for processing said digital image data, said line structure extraction unit generating at least one line orientation map and at least one line strength map for said tissue region for at least one scale, using separable filters;
a feature map generator unit for calculating spicule feature values based on said at least one line orientation map and said at least one line strength map; and
a spicule candidate determining unit for identifying a spicule candidate based on said calculated features values.

15. The apparatus according to claim 14, wherein said line structure extraction unit computes line strength at angle θ by performing successive one-dimensional filtering in the x-direction and the y-direction, to generate said at least one line strength map for said tissue region.

16. The apparatus according to claim 15, wherein said separable filters are represented by:
$$\begin{matrix}{w}_{σ , 1} ( x , y ) = [ \frac{{x}^{2}}{{σ}^{2}} - 1 ] exp ( - \frac{{x}^{2} + {y}^{2}}{2 {σ}^{2}} ) \\ {w}_{σ , 2} ( x , y ) = [ \frac{xy}{{σ}^{2}} ] exp ( - \frac{{x}^{2} + {y}^{2}}{2 {σ}^{2}} ) \\ {w}_{σ , 3} ( x , y ) = [ \frac{{y}^{2}}{{σ}^{2}} - 1 ] exp ( - \frac{{x}^{2} + {y}^{2}}{2 {σ}^{2}} )\end{matrix}$$
wherein σ is s scale parameter.

17. The apparatus according to claim 14, wherein said separable filters are steerable filters.

18. The apparatus according to claim 14, wherein said line structure extraction unit performs thinning for said at least one line strength map.

19. The apparatus according to claim 14, wherein said feature map generator unit calculates spicule feature values by calculating, for each of a plurality of pixels of interest, at least one of a line concentration measure, a directional entropy measure, a line orientation diversity measure, and a linearity measure, using said at least one line orientation map and said at least one line strength map.

20. The apparatus according to claim 19, wherein said linearity measure is a weighted feature as a function of line intensity.

21. The apparatus according to claim 14, wherein said feature map generator unit smoothens said spicule feature values to obtain smoothed spicule feature values.

22. The apparatus according to claim 21, wherein said spicule candidate determining unit identifies a spicule candidate using said calculated spicule features values and said smoothed spicule feature values.

23. The apparatus according to claim 14, wherein said line structure extraction unit removes pectoral edge lines from said at least one line strength map.

24. The apparatus according to claim 14, wherein said line structure extraction unit merges said at least one line orientation map and said at least one line strength map for said at least one scale to obtain a line structure map, wherein said at least one scale includes at least two scales, and wherein said line structure map is used by said feature map generator unit.

25. The apparatus according to claim 14, wherein said spicule candidate determining unit includes a Support Vector Machine classifier to detect a spicule candidate based on said calculated features values.

26. The apparatus according to claim 14, wherein said tissue region is included in a breast region.
